(19) United States
(12) Patent Application Publication
(10) Pub. No.: US 2003/0140231 A1
(43) Pub. Date: Jul. 24, 2003

(54) Operating method for a reception computer

(76) Inventors: Thomas Birkholzer, Radolfzell (DE); Frank Krickhahn, Herzogenaurach (DE); Jurgen Vaupel, Weisendorf (DE)

Correspondence Address: SCHIFF HARDIN & WAITE, 6600 SEARS TOWER, 233 S WACKER DR, CHICAGO, IL, 60606-6473, US

(21) Appl. No.: 10/306,192

(22) Filed: Nov. 27, 2002

(30) Foreign Application Priority Data
Nov. 29, 2001 (DE) 10158759.7

(51) Int. Cl. H04K 1/00; G06F 11/30; G06F 17/60

(52) U.S. Cl. 713/182; 713/201; 705/51

(57) ABSTRACT

A reception computer automatically accepts an inquiry communicated from a user computer. The inquiry contains at least one inquirer identification, a question and a question authorization. The inquirer identification contains a user name and a password. The reception computer automatically compares the inquirer identification to inquirer authorizations deposited in an inquirer list. Only if coincidence exists, the reception computer automatically outputs the question to an operator of the reception computer via an output medium, so that the operator can directly perceive it.

### BACKGROUND OF THE INVENTION

1. Field of the Invention

The present invention is directed to an operating method for a reception computer, wherein the reception computer automatically accepts an inquiry communicated from a user computer, the inquiry containing at least one inquirer identification and a question, wherein the inquirer identification contains a user name and a password, wherein the reception computer automatically compares the inquirer identification to inquirer authorizations deposited in an inquirer list, and wherein the reception computer automatically implements an activity based on the question given a coincidence.

2. Description of the Prior Art

Every communication of a user computer with a reception computer protected by a user name and a corresponding password ensues in the manner set forth above. European Application 0 890 919 and the DP-Info-Service of the German Patent and Trademark Office examples.

An operating method for a reception computer is also known wherein the reception computer automatically accepts an inquiry communicated from a user computer when it contains at least one inquirer identification and a question, and the reception computer automatically outputs the question (and the inquirer identification as well) to an operator of the reception computer via an output medium, so that it is directly perceptible to one of the sensory organs of the operator. An example is the assistant search in the DEPATIS.

In the health field, information and data arise at many different location in the framework of treating patients, for example at different physicians or hospitals. Theoretically, it is possible to store all of this information and data in computers and to network these computers with one another such that every attending physician can fetch the data and information worldwide as needed (and given authorization).

In practical terms, such a comprehensive networking cannot be realized in the foreseeable future. In the more immediate future, it will therefore continue to be partly or completely necessary to get documents about patient in a largely manual way. There are estimates that up to 20% of the work time is currently required for getting such papers, i.e. for an activity that is not in the core area of medical activity. This burdens the physician or his/her support personnel to an extraordinary extent.

### SUMMARY OF THE INVENTION

An object of the present invention is to provide a method that relieves attending physicians or their support personnel of such measures that are more administration-oriented than medical.

This object is achieved in a method wherein the aforementioned inquiry additionally contains a question authorization, and wherein the reception computer—as the activity to be implemented—outputs the question to an operator of the reception computer via an output medium, so that the operator can directly perceive it.

As a result, it is possible to send documentation for the authorization to ask this question, i.e. for access to the sensitive personal data of a patient, to the reception computer in addition to the question, namely in the form of the question authorization, and to have the question authorization and/or the question reviewed by a person for security purposes.

The activity outsourced from the attending physician or his/her support personnel must now be carried out by the operator of the reception computer. Nonetheless, an increase in efficiency is achieved as a result of the inventive measures. As a result of the automatic acceptance of the questions by the reception computer inquiries can be communicated to the operator in a simple way. And since the operator is specialized for getting such information, the information often can be acquired considerably faster.

If the inquirer identification does not coincide with any of the inquirer authorizations stored in the inquirer list, the reception computer preferably automatically communicates a corresponding message to the user computer. As a result thereof, the user is informed why the inquiry is not being processed.

When, given a coincidence, the reception computer first automatically checks a counter reading allocated to the inquirer identification for satisfying a counter reading condition and only outputs the question via the output medium when the counter reading condition has been met, a user who is otherwise authorized can be excluded as an exception from the use of the reception computer in a simple way.

Preferably, the reception computer again automatically communicates a corresponding message to the user computer when the counter reading condition has not been met. In this case as well as the user is informed why his/her inquiry is not being processed.

If the counter reading condition is satisfied by the counter reading exceeding a threshold, then the determination of the counter reading condition is especially simple. The threshold optionally can be inquirer identification-specific or the same for all counter readings of all users.

The reception computer can automatically periodically decrement the counter readings allocated to the inquirer authorizations by change values, then a type of subscription can be realized in a simple way. The change values optionally can be inquirer authorization-specific or the same for all counter readings.

The reception computer can decrement a counter reading allocated to the inquirer identification by a question-specific change value, so an outlay-specific adaptation of the counter reading can be realized in a simple way. For example, the question-specific change value can be dependent on the number of communicated inquiries, the type of communicated questions or on the scope of the answer determined on the basis of the question.

The reception computer can accept the inquirer identification in advance and the reception computer, in the event of a coincidence, or a coincidence and fulfillment of the counter reading condition, automatically communicates a questionnaire to the user computer with which the question and the question authorization can be communicated from the user computer to the reception computer. The communication of the question and of the question authorization thus is standardized, and thus can be further-processed in an especially simple way. In particular, the reception computer can also undertake evaluations.

In addition to the inquirer identification, the reception computer also can accept a user computer identification, at least one user computer authorization is allocated to the inquirer authorizations and the reception computer outputs the question via the output medium only when the user computer identification coincides with a user computer authorization allocated to the inquirer identification, then it is even more dependably assured that inquiries can be made only by persons who are in fact authorized.

The reception computer, before outputting the question via the output medium, can decipher at least the question, when the transmission to the reception computer ensues encrypted. The data security is higher as a result.

On the basis of the question authorization and the question, the reception computer can automatically determine whether a reply condition is fulfilled, so it can be determined in a simple way whether the user is authorized to ask the communicated question. The data security thus can be enhanced even further.

The reception computer can output the question via the output medium only when the reply condition is met, so impermissible questions are kept away from the operator of the reception computer in a simple way.

The reception computer can output the question and the question authorization via the output medium, so a check of the authorization of the user to ask the communicated question can ensue in a simple way for the operator of the reception computer.

On the basis of the question, the reception computer can automatically determine at least one proposal for an activity for determining an answer to the question and outputs the proposal via the output medium, so the preparation of an answer is facilitated for the operator of the reception computer.

The operator can prescribe an activity for determining an answer to the question for the reception computer via an input medium and the reception computer can execute the activity, so the same computer can be employed for the acceptance of the inquiry as well as for determining a reply to the inquiry.

The prescription of the activity can ensue by interactive confirmation or selection of a proposal output via the output medium, so the prescription of the activity is possible in an especially simple and comfortable way.

The reception computer can communicate an answer to the question to the user computer, so the answer also can be communicated to the user computer in an electronic way.

The reception computer can accept the answer unencrypted, and encrypt the answer and communicated the answer to the user computer in encrypted form, so the data security in the communication of the answer is especially high.

The reception computer can automatically convert the answer from a form in which the operator can directly perceive it into a form in which it can be communicated from the reception computer to the user computer. Papers and other information that are not directly machine-readable can also be communicated from the reception computer to the user computer.

When the reception computer archives the answer, then an archive arises in the reception computer over the course of time, so that less recourse to external information sources must be made over the course of time for preparing answers to questions.

The questions can involve a patient-related medical situation, so the operating method has an especially great field of application.

The reception computer can communicate with the user computer via a point-to-point connection, so the data security is higher than given a communication via a computer network.

### DESCRIPTION OF THE DRAWINGS

FIG. 1 illustrates a computer network with a number of computers operable in accordance with the invention.

FIG. 2 is an example of an inquirer list in the inventive method.

FIG. 3 is an example of a questionnaire in the inventive method.

FIGS. 4-7 are flowcharts for explaining the inventive method.

### DESCRIPTION OF THE PREFERRED EMBODIMENTS

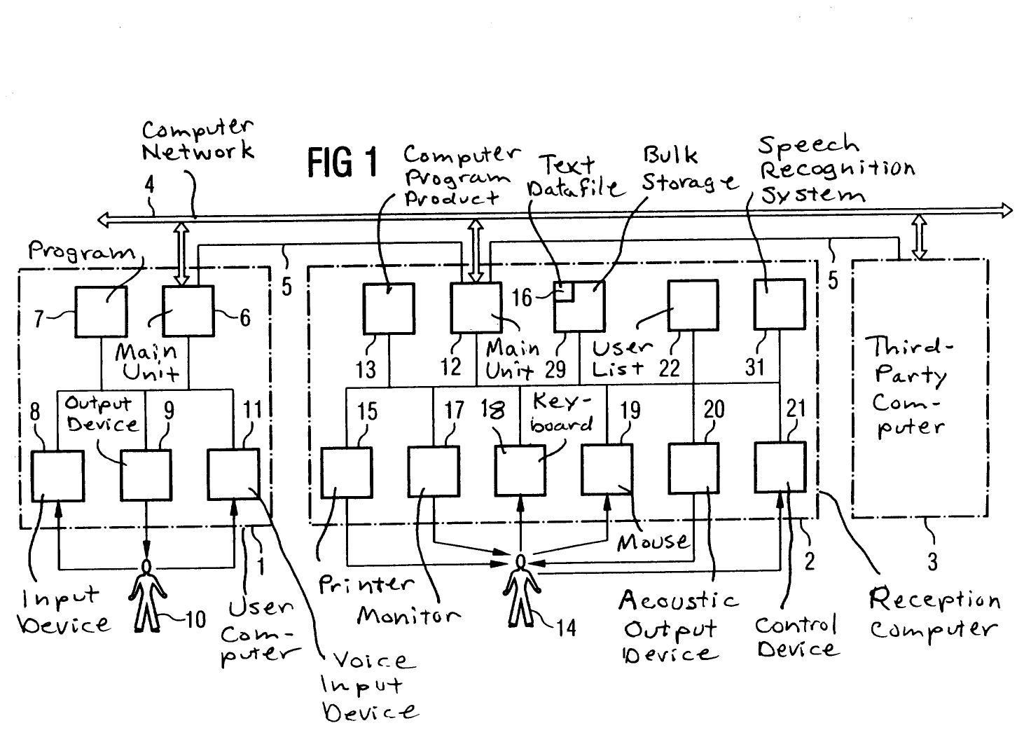

As shown in FIG. 1, a number of computers 1 through 3 are connected to a computer network 4. The computer network 4 optionally can be a local computer network (LAN) or a global computer network (for example, the Internet). The computer 1 is a user computer, the computer 2 is a reception computer, and the computer 3 is a third-party computer.

The user computer 1 has a main unit 5. The main unit 5 runs a program 6. In the framework of the running of the program 6, the main unit 5 communicates with a user 9 via an input device 7 and an output device 8. The user computer 1 also communicates with the reception computer 2 via the computer network 4 or a point-to-point connection 10.

The reception computer 2 also has a main unit 11. The main unit 11 runs a computer program product 12 that is stored in the reception computer 2.

In the processing the computer program product 12, the main unit 11 communicates with an operator 13 of the reception computer 2. For example, the reception computer 2 can provide direct outputs to the operator 13 via a printer 14 and a monitor 15, i.e. via output media, which the operator 13 can directly perceive. The reception computer 2 can also accept inputs from the operator 13 via a keyboard 16 and a mouse device 17. Via a scanner 18 or a speech recognition system 19, for example, the main unit 11 also can convert inputs from a form in which the operator 13 can directly perceive them into a form in which they can be electronically further-processed. For example, such inputs can be communicated from the reception computer 2 to the user computer 1 via the computer network 4 or via the point-to-point connection 10. The reception computer 2, in the processing of the computer program product 12, also can communicate via the computer network 4 or the point-to-point connection 10 with the user computer 1 and, as warranted, with the third-party computer 3 as well.

The third-party computer 3 is of secondary significance in the framework of the present invention. Its only relevancy is that data are stored therein that can be transmitted to the user computer 1 and/or to the reception computer 2.

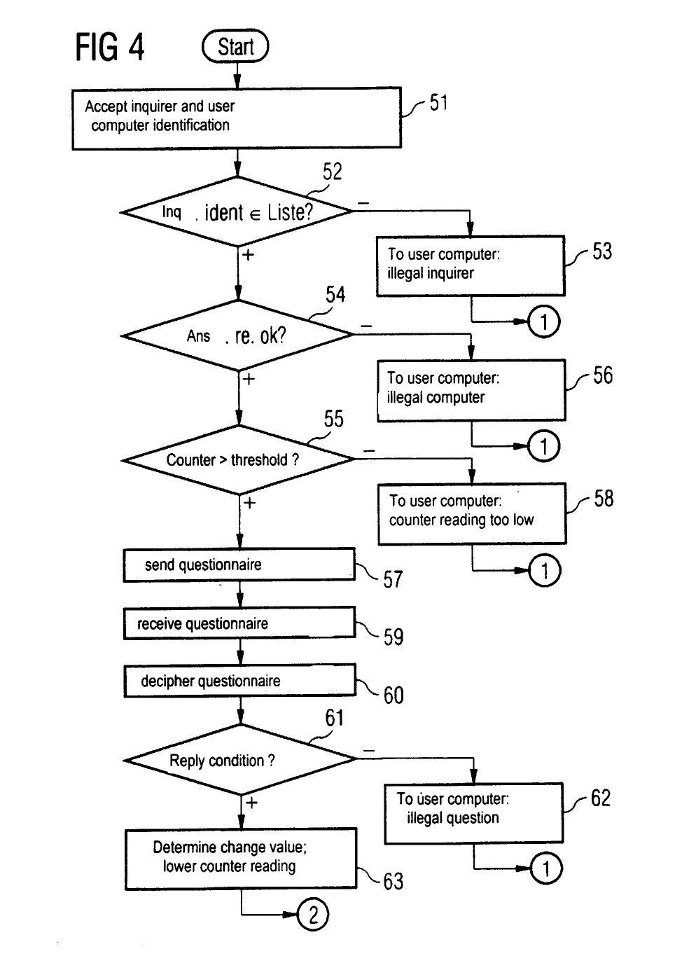

By running the computer program product 12, the reception computer 2 executes the operating method described below in conjunction with FIGS. 4 through 7.

As shown in FIG. 4, the reception computer 2 first provisionally accepts a an inquirer identification and a user computer identification in a step 51. As is generally standard, the inquirer identification is composed of a user name and of a password and the user computer identification is composed of an address or of a telephone connection proceeding from which the user computer 1 communicates with the reception computer 2.

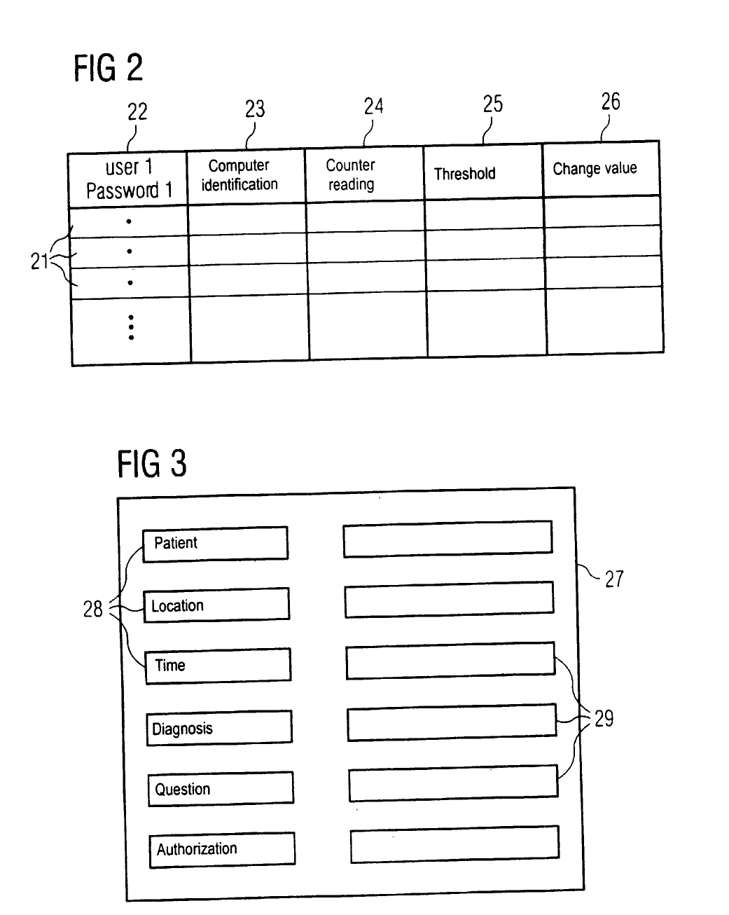

In a step 52, the reception computer 2 then accesses an inquirer list 20 (see FIG. 2). The inquirer list 20 contains a number of lines 21. Each line 21 contains number of entries 22 through 26. The entry 22, for example, corresponds to an inquirer authorization. It thus contains a combination of a user name and a password. By comparing the incoming user name and the incoming password to the inquirer authorizations stored in the inquirer list 20, a check can thus be performed to determine whether the user 9 is authorized to send questions to the reception computer 2. If the communicated data do not coincide with any of the inquirer authorizations stored in the inquirer list 20, then the reception computer 2 automatically communicates a corresponding message to the user computer 1 in a step 53. Otherwise, a step 54 follows.

In step 54, the reception computer 2 compares the communicated user computer identification to allowable user computer authorizations that are contained in the entry 23. The entry 23 may contain a number of user computer authorizations. A step 55 follows only if the comparison of the user computer identification coincides with one of the allocated user computer authorizations. Otherwise a branch is made to a step 56 in which the user 9 is informed why the user 9 is not allowed to communicate with the reception computer 2.

In step 55, a counter reading that is stored in the entry 24 is compared to a threshold that is stored in the entry 25. If the counter reading exceeds the threshold, then a counter reading condition has been satisfied. A step 57 is implemented when the counter reading condition has been satisfied. Otherwise, the reception computer 2 automatically communicates a corresponding message to the user computer 1 in a step 58. As a result of the storage of the threshold in the entry 25, this can be inquirer identification-specific, however, it is also possible for the threshold to be the same for all counter readings.

In step 57, the reception computer 2 automatically communicates a questionnaire 27 to the user computer 1. As shown in FIG. 3, the questionnaire 27 contains a number of prescribed text fields 28 and a number of input fields 29. It can be displayed on the output device 8 as a mask and can be interactively filled out by the user 9 via the input device 7. For example, details with respect to a person (patient), a type of treatment, a time of treatment, a diagnosis, etc., can be entered into the input fields 29. Further, a question, i.e. what information is wanted, can be entered into at least one of the input fields 29. The authorization of the user 9 to ask this question can be entered into another of the input fields, i.e. a question authorization. Which item is to be entered into which of the input fields 29 is indicated as a result of the allocated text field 28. Using the questionnaire 27, it is assured in a simple way that the question and the question authorization will be correctly communicated from the user computer 1 to the reception computer 2, as will the patient-related medical situation to which the question relates.

In a step 59, the reception computer 2 then receives the filled-out questionnaire 27. The transmission of the filled-out questionnaire 27 preferably ensues in encrypted form. The questionnaire 27—and, in particular, the question and the question authorization together are first deciphered by the reception computer 2 in a step 60.

In a step 61 after the questionnaire 27 has been deciphered, the reception computer 2 automatically checks on the basis of the question authorization and the question whether the user 9 is authorized to ask this question. As warranted, the user identification can be additionally utilized for the check. In any case, however, the question authorization is an input separate from the user identification.

The reception computer 2 thus determines whether an answer condition is satisfied. If the answer condition has not been satisfied, the reception computer 2 automatically communicates a message to the user computer 1 in a step 62 to the effect that the user 9 is not authorized to ask this question. When, in contrast, the answer condition has been satisfied, the reception computer 2 initially determines a question-specific change value in a step 63 and then decrements the counter reading stored in the entry 24 by this change value.

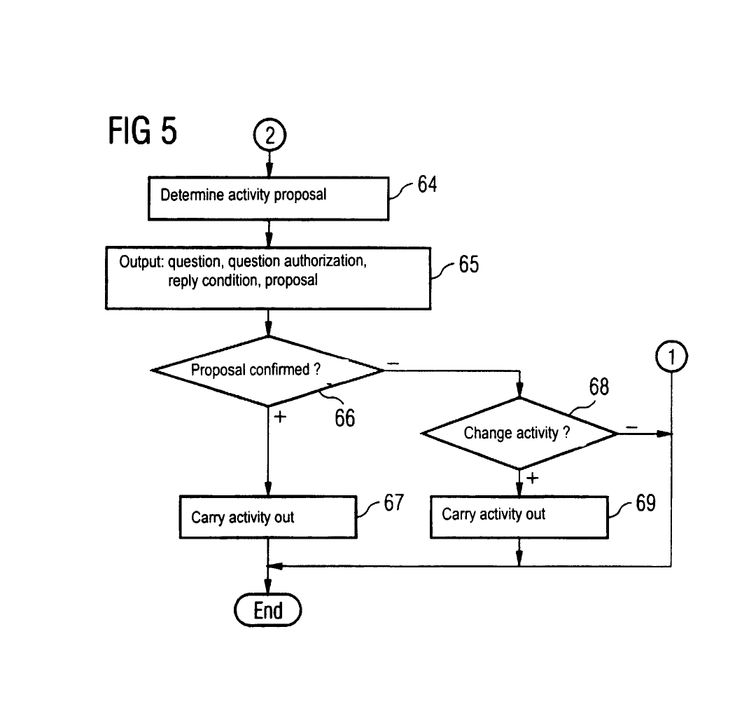

As shown in FIG. 5, the reception computer 2 then automatically determines at least one proposal for an activity for determining an answer to the question in a step 64. In a step 65, the question, the question authorization, the answer condition determined by the reception computer 2 and the proposal or, respectively, proposals for an activity are then output. All of this information can be directly perceived (seen) by the operator 13. The output can thereby optionally ensue via the printer 14 or the monitor 15.

Given output via the monitor 15, the reception computer 2 checks in a step 66 whether the operator has interactively selected one of the activity proposals determined by the reception computer 2, or confirmed the proposed activity that has been selected. If yes, then this activity is carried out in a step 67. Otherwise, the reception computer 2 checks in a step 68 whether the operator 13 is prescribing such an activity for it via the keyboard 16 or the mouse device 17. If this is the case, this activity is carried out in a step 69. For example, the activity that is carried out by the reception computer 2 can be the preparation or the production of letters. It is also possible for the reception computer 2 to produce or prepare an inquiry for information at the third-party computer 3. As warranted, it is also possible to communicate a request to the third-party computer 3 to directly communicate the desired information to the user computer 1 or to the user 9. This latter can ensure, for example, by post.

The production of the answer to the question that has been accepted thus does not ensue fully automatically—as can be seen from the above-described procedure—but either manually or interactively. For example, it is possible for the proposed activities to be completely carried out by the operator 13, or for the reception computer 2 not to determine any proposals at all since this lies completely in the area of responsibility of the operator 13.

When the answer to the question has been prepared, this answer is communicated to the user 9. For example, this can occur by dispatching documents (files, images, medical reports, etc.) through the mail. Insofar as they exist in machine-readable form, it is also possible to store such documents on a mobile data carrier (diskette, CD) and to send this data carrier to the user 9. It is also possible to implement the communication of the answer within the framework of the operating method for the reception computer 2.

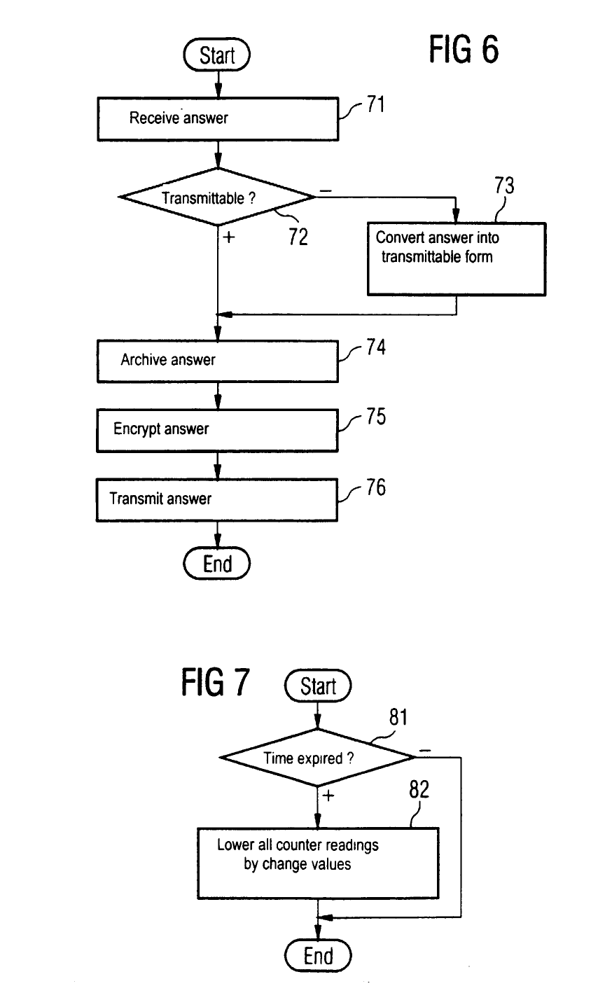

In this case, the reception computer 2 according to FIG. 6 first receives an answer to the question in a step 71. Dependent on whether the answer exists in a form in which it can be communicated from the reception computer 2 to the user computer 1 or not, a branch is made from a step 72 to a step 73 as warranted. In the step 73, the reception computer 2 automatically converts the answer from a form in which the operator 13 can directly perceive it into a form in which it can be transmitted from the reception computer 2 to the user computer 1. For example, a document present in paper form is read in via the scanner 18 or spoken words are entered as an input via the speech recognition system 19. The reception computer 2 then archives the answer in a step 74. It thus saves it in an archive datafile 30.

The reception computer 2 usually receives the answer unencrypted. For enhancing the data security, the reception computer 2 therefore encrypts the answer in a step 75 before it communicates the answer to the user computer 1 in encrypted form in a step 76.

In the framework of the operating method, the reception computer 2 also implements a step 81, for example interrupt-controlled. In step 81, the reception computer 2 checks whether a prescribed time has elapsed. If yes, the reception computer 2 automatically de-increments all counter readings allocated to the inquirer authorizations by change values in a step 82. The deincrementing of the counter readings ensues periodically as a result of being implemented given time expiration. Since the charge values are stored in the entries 26, the change values can be inquirer authorization-specific, however, alternatively they can be the same for all counter readings.

As a result of the inventive operating method, sensitive data can be exchanged between the user 9 and the operator 13 in a simple and nonetheless secure way.

Although modifications and changes may be suggested by those skilled in the art, it is the intention of the inventors to embody within the patent warranted hereon all changes and modifications as reasonably and properly come within the scope of their contribution to the art.

We claim as our invention:

1. An operating method for a reception computer, comprising the steps of:
at said reception computer, automatically accepting an inquiry communicated to said reception computer from a user computer, said inquiry containing at least one inquirer identification containing a user name and a password, a question, and a question authorization;
automatically comparing, in said reception computer, said inquirer identification to inquirer authorizations stored in an inquirer list in said reception computer; and
only upon coincidence between said inquirer identification and one of said inquirer authorizations, said reception computer automatically making said question available to an operator of said reception computer via an output medium in a form allowing said operator to directly perceive said question.

2. An operating method as claimed in claim 1 comprising automatically communicating, from said reception computer, a message to said user computer if said inquirer identification does not coincide with any of said inquirer authorizations stored in said inquirer list.

3. An operating method as claimed in claim 1 comprising, upon coincidence of said inquirer identification with one of said inquirer authorizations, automatically checking, in said reception computer, a counter reading allocated to said inquirer identification and determining whether said counter reading satisfies a counter reading condition, and making said question available from said reception computer via said output medium only if said counter reading condition is satisfied.

4. An operating method as claimed in claim 3 comprising automatically communicating a message from said reception computer to said user computer if said counter reading condition is not satisfied.

5. An operating method as claimed in claim 3 comprising determining that said counter reading condition is satisfied if said counter reading exceeds a threshold.

6. An operating method as claimed in claim 5 comprising employing an inquirer-identification specific threshold as said threshold.

7. An operating method as claimed in claim 5 comprising employing the same threshold for all counter readings respectively allocated to different inquirer identifications.

8. An operating method as claimed in claim 3 comprising automatically periodically lowering, in said reception computer, the respective counter readings allocated to said inquirer authorizations, by respective change values.

9. An operating method as claimed in claim 8 comprising employing inquirer authorization-specific change values as said change values.

10. An operating method as claimed in claim 8 comprising employing the same change values for all counter readings respectively allocated to said inquirer authorizations.

11. An operating method as claimed in claim 3 comprising in said reception computer, lowering a counter reading allocated to said inquirer identification by a question-specific change value.

12. An operating method as claimed in claim 1 comprising accepting said inquirer identification at said reception computer in advance of said question and question authorization, and upon coincidence of said inquirer identification with one of said inquirer authorizations, automatically communicating a questionnaire from said reception computer to said user computer and employing said questionnaire at said user computer to communicate said question and said question authorization from said user computer to said reception computer.

13. An operating method as claimed in claim 1 comprising, in addition to said inquirer information, accepting a user computer identification at said reception computer, allocating at least one user computer authorization respectively to said inquirer authorizations, and said reception computer making said question available via said output medium only if said user computer identification coincides with a user computer authorization allocated to the inquirer.

14. An operating method as claimed in claim 1 comprising accepting said inquiry at said reception computer with at least said question being encrypted, and comprising the additional step of deciphering said question in said reception computer before making said question available via said output medium.

15. An operating method as claimed in claim 1 comprising, based on said question authorization and said question, automatically determining in said reception computer whether a reply condition is satisfied.

16. An operating method as claimed in claim 15 comprising making said question available from said reception compute via said output medium only if said reply condition is satisfied.

17. An operating method as claimed in claim 1 comprising making said question authorization available from said reception computer via said output medium in addition to said question.

18. An operating method as claimed in claim 1 comprising, based on said question, automatically determining in said reception computer at least one proposal for an activity associated with answering said question, and making said proposal available from said reception computer to an operator via said output medium.

19. An operating method as claimed in claim 18 comprising conducting an interactive confirmation procedure with an operating of said reception computer via said output medium and via an input medium of said reception computer to confirm said proposal.

20. An operating method as claimed in claim 1 comprising entering an operator-prescribed activity for answering said question into said reception computer via an input medium, and executing said activity in said reception computer.

21. An operating method as claimed in claim 20 comprising conducting an interactive selection procedure with said operator of said reception computer via said input medium and said output medium to generate said operator-prescribed activity.

22. An operating method as claimed in claim 1 comprising communicating an answer to said question from said reception computer to said user computer.

23. An operating method as claimed in claim 22 comprising encrypting said answer in said reception computer to produce an encrypted answer, and communicating said encrypted answer to said user computer.

24. An operating method as claimed in claim 21 comprising generating said answer in said reception computer in a form in which said answer is directly perceivable by said operator, and converting said answer in said reception computer into a form for communication from said reception computer to said user computer.

25. An operating method as claimed in claim 21 comprising archiving said answer in said reception computer.

26. An operating method as claimed in claim 1 comprising employing a question relating to a patient-related medical situation as said question in said inquiry.

27. An operating method as claimed in claim 1 comprising communicating between said reception computer and said user computer via a point-to-point connection.

28. A computer program product loadable into a reception computer for configuring said reception computer to automatically accept an inquiry communicated to said reception computer from a user computer, said inquiry containing at least one inquirer identification containing a user name and a password, a question, and a question authorization, and to automatically compare said inquirer identification to inquirer authorizations stored in an inquirer list in said reception computer, and, only upon coincidence between said inquirer identification and one of said inquirer authorizations, to ensure said reception computer to automatically make said question available to an operator of said reception computer via an output medium in a form allowing said operator to directly perceive said question.
